(19) United States
(12) Patent Application Publication
(10) Pub. No.: US 2005/0050309 A1
(43) Pub. Date: Mar. 3, 2005

(54) Data processor

(75) Inventors: Hajime Yamashita, Kodaira (JP); Kiwamu Takada, Kodaira (JP); Takahiro Irita, Higashimurayama (JP); Toru Hiraoka, Hadano (JP)

Correspondence Address: MILES & STOCKBRIDGE PC, 1751 PINNACLE DRIVE, SUITE 500, MCLEAN, VA, 22102-3833, US

(73) Assignees: Renesas Technology Corp.; SuperH, Inc.

(21) Appl. No.: 10/927,199

(22) Filed: Aug. 27, 2004

(30) Foreign Application Priority Data
Aug. 29, 2003 (JP) 2003-305650

(51) Int. Cl. G06F 9/30

(52) U.S. Cl. 712/239

(57) ABSTRACT

A data processor for executing branch prediction comprises a queuing buffer (23) allocated to an instruction queue and to a return destination instruction queue and having address pointers managed for each instruction stream and a control portion (21) for the queuing buffer. The control portion stores a prediction direction instruction stream and a non-prediction direction instruction stream in the queuing buffer and switches an instruction stream as an execution object from the prediction direction instruction stream to the non-prediction direction instruction stream inside the queuing buffer in response to failure of branch prediction. When buffer areas (Qa1, Qb) are used as the instruction queue, the buffer area (Qa2) is used as a return instruction queue and the buffer area (Qa1) is used as a return instruction queue. A return operation of a non-prediction direction instruction string at the time of failure of branch prediction is accomplished by stream management without using fixedly and discretely the instruction queue and the return destination instruction queue.

### CLAIM OF PRIORITY

The present application claims priority from Japanese Patent Application JP 2003-305650 filed on Aug. 29, 2003, the content of which is hereby incorporated by reference into this application.

### BACKGROUND OF THE INVENTION

1. Field of the Invention

This invention relates to a data processor. More particularly, the invention relates to control of instruction-fetch and speculation instruction execution in a prediction direction in a data processor for executing branch prediction. For example, the invention relates to a technology that will be effective when applied to a data processor or microcomputer fabricated into a semiconductor integrated circuit.

2. Description of the Related Art

A technology that stores an instruction string on a prediction side in an instruction queue exists as one of the instruction pre-fetch technologies by branch prediction. Read/write pointer management from and to an instruction queue is made by a controller. When branch prediction fails, an instruction of a return destination must be fetched from a program memory, or the like, and must then be supplied to an instruction decoder. Therefore, penalty due to the failure of branch prediction becomes great and efficiency drops from the aspect of the instruction-fetch operation of the return destination after branch prediction fails.

Patent Document 1 (see JP-A-7-73104 (esp. FIG. 2)) describes an instruction pre-fetch technology of this kind. In this reference, a small buffer referred to as “branch prediction buffer” stores a group of instructions that may be required from an instruction cache at the time of failure of branch prediction. To confirm whether or not an instruction corresponding to a target address is usable at the time of the failure of branch prediction, the branch prediction buffer is checked. When the instructions are usable, these instructions are copied to an appropriate buffer. When the instructions corresponding to the target addresses are not usable, these instructions are fetched from the instruction cache and are arranged in a buffer, and selectively in a branch prediction buffer.

Another technology employs a return destination queue with an instruction queue. An instruction string on the prediction side is stored in the instruction queue and an instruction string on the non-prediction side is stored in the return destination instruction queue. Read/write pointers of the return destination instruction queue and read/write pointers of the instruction queue are separately managed. When branch prediction fails, the instruction string of the return destination is supplied from the return destination instruction queue to an instruction decoder. The instruction string to be continued is fetched and stored in the instruction queue in parallel with the supply of the instruction from the return destination instruction queue to the instruction decoder. When the instructions of the return destination stored in the return destination instruction queue run out, the instruction supplying party to the instruction decoder is controlled and switched to the instruction queue.

### SUMMARY OF THE INVENTION

According to the technology described above that employs the return destination instruction queue with the instruction queue, too, the operation of the respective read/write pointers for linking the instruction queue with the return destination instruction queue at the time of the failure of branch prediction is complicated. Control logic for this purpose becomes complicated, too, and pointer management is not efficient. When branch prediction fails, the number of cycles necessary for the return operation affects instruction execution performance.

It is an object of the invention to provide a data processor that makes it easy to link an instruction queue with a return destination instruction queue.

It is another object of the invention to provide a data processor that can reduce a cycle number required for a return operation when branch prediction fails and can improve instruction execution performance.

The above and other objects and novel features of the invention will become more apparent from the following description of the specification taken in connection with the accompanying drawings.

The outline of typical inventions among the inventions disclosed in this application will be briefly explained as follows.

[1] A data processor for executing branch prediction, comprising a queuing buffer (23) allocated to an instruction queue (IQUE) and to a return destination instruction queue (RBUF) and having address pointers (rpi, wpi) managed for each instruction stream and a control portion (21) for the queuing buffer, wherein the control portion stores a prediction direction instruction stream and a non-prediction direction instruction stream in the queuing buffer and switches an instruction stream as an execution object from the prediction direction instruction stream to the non-prediction direction instruction stream inside the queuing buffer in response to the failure of branch prediction.

An instruction as a starting point of the instruction stream is, for example, an instruction whose execution is started after resetting and a branch destination instruction, and an instruction as an end point of the instruction stream is, for example, an unconditional branch instruction and a conditional branch instruction predicted as branched.

The queuing buffer described above includes a first storage area (Qa1) and a second storage area (Qa2) to which the same physical address is allocated, for example, and allocation of either one of the first and second storage areas to the instruction queue and the other to the return destination instruction queue is changeable. The data processor further includes a third storage area (Qb) to which a physical address continuing the physical addresses allocated respectively to the first and second storage areas is allocated, and the third storage area may well be allocated to a part of the instruction queue continuing the first or second storage area allocated to the instruction queue.

Because the address pointer is managed for each instruction stream in the queuing buffer, it is only necessary to switch the address pointer used for reading out the instruction queued to the address pointer of the instruction stream used when the instruction stream as the execution object is switched from the prediction direction instruction stream to the non-prediction direction instruction stream inside the queuing buffer. Because the address pointer so switched becomes the address pointer of the prediction direction instruction stream at that point, it is only necessary to continuously use this address pointer to continue storage of the prediction direction instruction stream. Consequently, control of linking of the instruction queue with the return destination instruction queue becomes easy and when the failure of branch prediction occurs, the number of cycles required for the return direction becomes small and instruction execution performance can be improved.

As a concrete embodiment of the invention, the control portion stores the non-prediction direction instruction stream (that is, branch destination stream in the case of branch) in the return destination instruction queue when the branch prediction is non-branch. When the branch prediction is branch, on the other hand, the control portion may well store the non-prediction direction instruction stream in an empty area of the instruction queue. The term “empty” of the instruction queue means a storage area relating to an instruction stream to which the branch instruction predicted as branch by the branch prediction belongs. In short, because branch prediction is branch, the instruction pre-fetch address is changed to the branch destination in accordance with this prediction. However, because this prediction needs at least pre-decoding of the branch instruction, an instruction (instruction string in the non-prediction direction as a part of non-prediction direction instruction stream) for which pre-fetch is required precedently after pre-f etch of the branch instruction to prediction is stored in the instruction queue, too. Therefore, a storage stage of the return instruction queue need not be purposely spared for storing the non-prediction direction instruction stream when branch prediction is branch.

The control portion switches allocation of the return destination instruction queue to the instruction queue and the instruction queue to the return destination instruction queue in response to the failure of branch prediction when the non-prediction instruction stream exists in the return destination instruction queue. On the other hand, the control portion uses the non-prediction direction instruction stream of the empty area as the instruction stream to be executed in response to the failure of branch prediction when the non-prediction direction instruction stream exists in the empty area of the instruction queue and stores the prediction direction instruction stream in succession to the non-prediction direction instruction stream. The data processor includes re-writable flag means for representing whether address pointers are address pointers of the instruction queue or address pointers of the return destination instruction queue, as a pair with the address pointer. Therefore, it is not necessary to separately dispose dedicated address pointers for the instruction queue and for the return destination instruction queue.

The data processor includes storage means for storing information for linking the non-prediction direction instruction stream stored in the queuing buffer with branch prediction relating to prediction of the non-prediction direction instruction. Therefore, the data processor can easily cope with the case where a plurality of non-prediction direction instruction streams exists. For example, there is the case where the storage areas of the non-prediction direction instruction stream are both empty areas of the instruction queue and the return destination instruction queue. In a more concrete embodiment, the storage means is a return instruction stream number queue for storing identification information of the non-prediction direction instruction streams stored in the queuing buffer in the sequence of execution of branch instruction.

The queuing buffer and its control portion described above are arranged in an instruction control portion of a central processing unit, for example. The data processor has an instruction cache memory connected to the central processing unit and is formed into a semiconductor chip.

The overall operation of the instruction pre-fetch by branch prediction of the data processor described above will be hereby explained. The branch direction is predicted in conditional branch. The instruction string in the prediction direction is stored in the instruction queue. The instruction string in a non-branching (ntkn: prediction-not-taken, prediction-ntkn) prediction direction that creates the instruction-fetch request before prediction of the branch direction is stored in the instruction queue and is used as the return destination instruction at the time of branch (tkn: prediction-taken, prediction-tkn) prediction. Its instruction stream is used as the return destination instruction stream. At the time of prediction-not-taken (ntkn), the fetch-request for the instruction string on the tkn side as the non-prediction side is created and stored in the return destination instruction queue and its instruction string is used as the return destination instruction stream. Correspondence between the conditional branch and the stream number for storing the return destination instruction string is stored in the return destination instruction stream number queue in the execution sequence of the conditional branch instructions. Branch condition judgment is made during execution of the conditional branch instruction and the return destination instruction stream number corresponding to the branch for which prediction fails is generated when the prediction fails. When the return destination instruction stream exists in the instruction queue, the return destination instruction is supplied from the instruction queue to the instruction decoder. When the return destination instruction stream exists in the return destination instruction queue, the return destination instruction queue and the instruction queue are replaced with each other and the queue storing the return destination instruction stream is used as the instruction queue. The return destination instruction is supplied from the instruction queue to the instruction decoder. Subsequently, the fetch of the instruction following the return destination instruction and the supply of the instruction to the instruction decoder can be made by stream management.

[2] According to another aspect of the invention, a data processor for executing branch prediction, comprises a queuing buffer allocated to an instruction queue and to a return destination instruction queue and having address pointers managed for each instruction stream, and a control portion for the queuing buffer, wherein the control portion stores a prediction direction instruction stream in the instruction queue, stores a non-prediction direction instruction stream in a return destination instruction queue when branch prediction is non-branch and stores the non-prediction instruction stream in an empty area of the instruction queue when branch prediction is branch.

Among the inventions disclosed in this application, the effects obtained by typical inventions will be briefly explained as follows.

The return operation of the non-prediction direction instruction string at the time of the failure of branch prediction can be accomplished by stream management without using fixedly and discretely the instruction queue and the return destination instruction queue. Therefore, control for linking the instruction queue and the return destination instruction queue can be simplified. When branch prediction fails, the number of cycles necessary for the return operation can be reduced and instruction execution performance can be improved.

### BRIEF DESCRIPTION OF THE DRAWINGS

FIG. 1 is a block diagram typically showing in detail a queuing buffer and an instruction stream management portion;

FIG. 2 is a block diagram of a microprocessor according to an embodiment of the invention;

FIG. 3 is a block diagram showing an example of an instruction control portion that a CPU has;

FIG. 4 is an explanatory view showing the state of a queuing buffer in which buffer areas Qa1 and Qb constitute an instruction queue and which uses a buffer area Qa2 as a return destination queue having m entries;

FIG. 5 is an explanatory view showing the state of the queuing buffer after allocation of an instruction queue and a return destination instruction queue is switched when ntkn prediction fails;

FIG. 6 is an explanatory view showing a concrete example of stream management by an instruction stream management portion;

FIG. 7 is an explanatory view typically showing an example of a pipeline operation of instruction-fetch and instruction execution;

FIG. 8 is an explanatory view typically showing a storage state of an instruction stream to an instruction queue and a return destination instruction queue;

FIG. 9 is an explanatory view of a return destination instruction stream number queue;

FIG. 10 9 is a flowchart typically showing a procedure of instruction stream control by an instruction-fetch control portion;

FIG. 11 is an explanatory view showing an effect by a return destination instruction queue at the time of failure of branch prediction with a comparative example; and

FIG. 12 is a block diagram schematically showing a construction of instruction-fetch by a Comparative Example with respect to FIG. 1.

### DESCRIPTION OF THE PREFERRED EMBODIMENTS

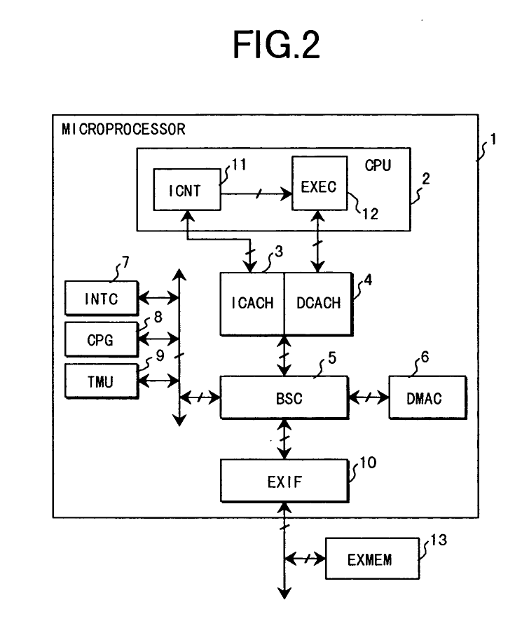

FIG. 2 shows a microprocessor 1 according to an embodiment of the invention that is also called a “semiconductor data processor” or a “microcomputer”. The microprocessor 1 shown in the drawing is formed on one semiconductor substrate of a single crystal silicon substrate by a CMOS integrated circuit production technology, for example.

The microprocessor 1 includes a central processing unit (CPU) 2, an instruction cache memory (ICACH) 3, a data cache memory (DCACH) 4, a bus state controller (BSC) 5, a direct memory access controller (DMAC) 6, an interrupt controller (INTC) 7, a clock pulse generator (CPG) 8, a timer unit (TMU) 9 and an external interface circuit (EXIF) 10. An external memory (EXMEM) 13 is connected to the external interface circuit (EXIF) 10.

The CPU 2 includes an instruction control portion (ICNT) 11 and an execution portion (EXEC) 12. The ICNT 11 executes branch prediction, fetches an instruction from the ICACH 3, decodes the instruction so fetched and controls the EXEC 12. The EXEC 12 includes a general-purpose register and an arithmetic unit that are not shown in the drawing, and executes the instruction by executing address operation and data operation by using control signals and control data supplied from the INCT 11. Operand data, etc, necessary for executing the instruction are read from the DCACH 4 or the external memory 13. The instruction temporarily stored in the ICACH 3 is read from the external memory (EXMEM) 13 through the EXIF 10. Here, the CPU 2 has a two-way super-scalar construction.

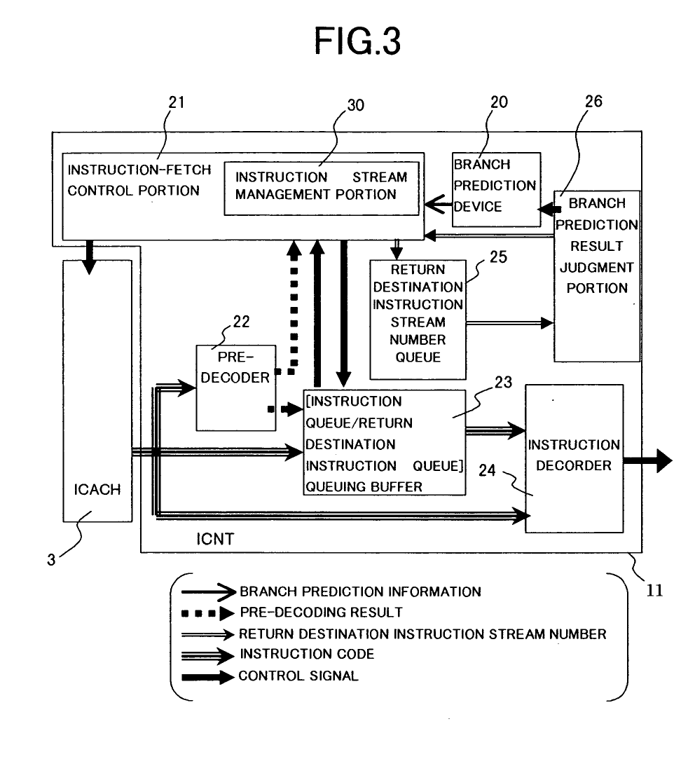

FIG. 3 shows an example of the execution control portion 11 described above. The instruction-fetch control portion 21 executes branch prediction and controls the instruction-fetch. The instruction read out from the ICACH 3 by the control of the instruction-fetch control portion 21 is supplied to a pre-decoder 22, a queuing buffer 23 and an instruction decoder 24. Readout of the instruction from the ICACH 3 is made in a 4-instruction unit though this is not particularly restrictive. Two instructions as the difference between the four (4) instructions read out from the ICACH 3 and two (2) instructions executed at one time by the CPU 2 are stored in an instruction queue of the queuing buffer 23. When the instruction to be executed is held by the instruction queue of the queuing buffer 23, the instruction outputted from the instruction queue is supplied to the instruction decoder 24. An instruction stream of a non-prediction direction is stored in a return destination instruction queue of the queuing buffer 23, etc. Management of an address pointer (read address pointer and write address pointer) for causing an FIFO operation of the queuing buffer 23 is made by an instruction stream management portion 30 of an instruction-fetch control portion 21 and the address pointer is hereby managed for each instruction stream. The pre-decoder 22 pre-decodes the instruction outputted from the ICACH 3 and judges in advance the existence/absence and the kind of the branch instruction. The judgment result is given to the instruction-fetch control portion 21. The instruction-fetch control portion 21 refers to a branch prediction device 20 having history information of branch for each branch instruction executed in the past, decides the branch prediction direction and executes address pointer management of the queuing buffer 23 for fetching the instruction stream of the branch prediction direction and the instruction stream of the non-prediction direction, memory access control and address pointer management of a return destination instruction stream number queue 25. The return destination instruction stream number queue 25 stores the identification information (stream number) of the non-prediction direction instruction stream stored in the queuing buffer 23 in the sequence of execution of the branch instructions. In almost all cases, it is the execution stage of the branch instruction that the branch condition of the branch instruction is determined and whether or not the branch prediction proves failure becomes clear in that stage. A branch prediction result judgment portion 26 judges whether or not the branch prediction proves failure based on the arithmetic result and the like in the EXEC12. Detecting the failure of the branch prediction, the instruction-fetch control portion 21 switches the instruction supplied from the queuing buffer 23 to the instruction decoder 24, to the instruction of the non-prediction direction instruction stream. At this time, as to which non-prediction direction instruction stream has to be switched to the execution instruction stream (instruction stream to be executed by the CPU) when a plurality of non-prediction direction instruction streams stored in the queuing buffer 23 exist, the instruction stream number of the return destination can be known when the branch prediction result judgment portion 26 recognizes the output of the return destination instruction stream number queue 25 and transmits this stream number to the instruction-fetch control portion 21.

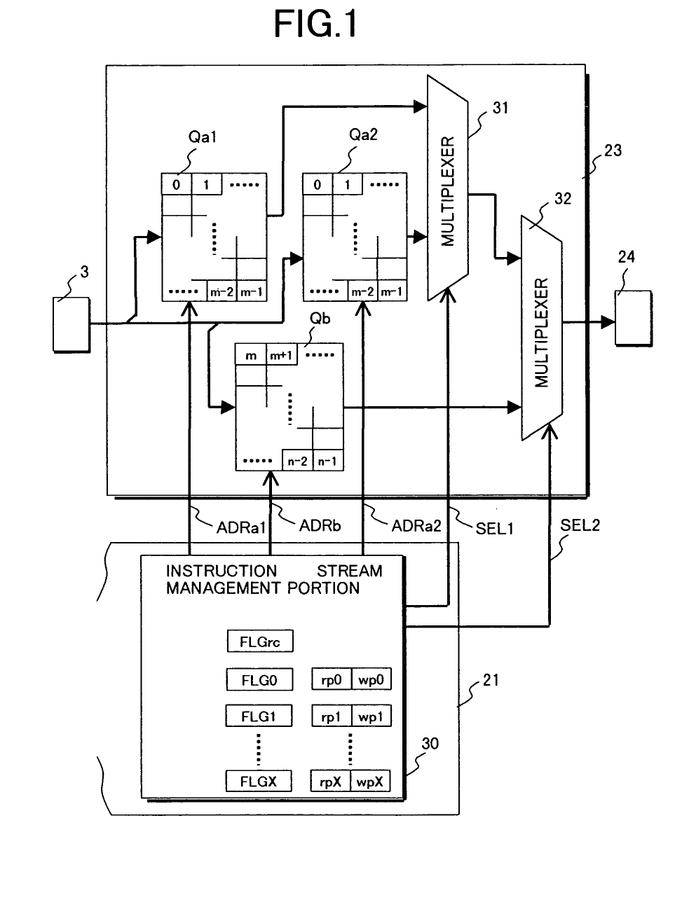

FIG. 1 shows the detail of the queuing buffer 23 and the instruction stream management portion 30. The queuing butter 23 has three buffer areas Qa1, Qa2 and Qb. Each of the buffer areas Qa1 and Qa2 has m entries (FIFO entries) and the number of 0 to m−1 (entry address) is allocated as the physical address to each entry. The buffer area Qb has n-m entries (n≧m) and the number m to n-1 (entry address) is allocated as the physical address to each entry. A read pointer rpi for reading out an instruction and a write pointer wpi (i=0 to X) for writing for utilizing the buffer areas Qa1, Qa2 and Qb as the queuing buffer, that is, FIFO (First-In First-Out), can be had for each instruction stream. The read pointer rpi and the write pointer wpi (simply called in some cases “address pointers rpi and wpi”, too) for each instruction stream are controlled by the instruction stream management portion 30. The read pointer rpi and the write pointer wpi can designate maximum n entries existing in the entry addresses 0 to n−1 of the buffer areas Qa1 and Qb or Qa2 and Qb. An arithmetic unit, not shown in the drawing, executes address calculation such as increment to the values of the read pointer rpi and the write pointer wpi and the values of the read pointer rpi and the write pointer wpi so calculated are given to each buffer area Qa1, Qa2 and Qb through a dedicated address line ADRa1, ADRa2 and ADRb. As to the buffer areas Qa1, Qa2 and Qb, Qa2 is used as the return destination instruction queue RBUF when Qa1 and Qb are used as one continuous instruction queue IQUE, and Qa1 is used as the return destination instruction queue RBUF when Qa2 and Qb are used as one continuous instruction queue IQUE.

A flag FLGi is disposed as a pair with each address pointer rpi, wpi in order to represent whether each address pointer rpi, wpi corresponds to the queue using the buffer area Qa1 or the queue using the buffer area Qa2. For example, FLGi=1 represents the Qa1 side and FLGi=0 represents the Qa2 side. There is further disposed a flag FLGrc representing which of the buffer areas Qa1 and Qa2 is allocated to the return instruction queue. For example, Qa1 represents the return instruction queue when FLGrc=1 and Qa2 represents the return instruction queue when FLGrc=0. The instruction stream management portion 30 can recognize by means of the flags FLGi and FLGrc whether the address pointers rpi and wpi for each of maximum X+1 instruction streams are the address pointers of the instruction queue or the address pointers for the return destination instruction queue.

The multiplexer 31 selects the output of one of the buffer areas Qa1 and Qa2 in accordance with a select signal SELL. A multiplexer 32 selects the output of the multiplexer 31 or the output of the buffer area Qb in accordance with a select signal SEL2 and the output of the multiplexer 32 is supplied to the instruction decoder 24.

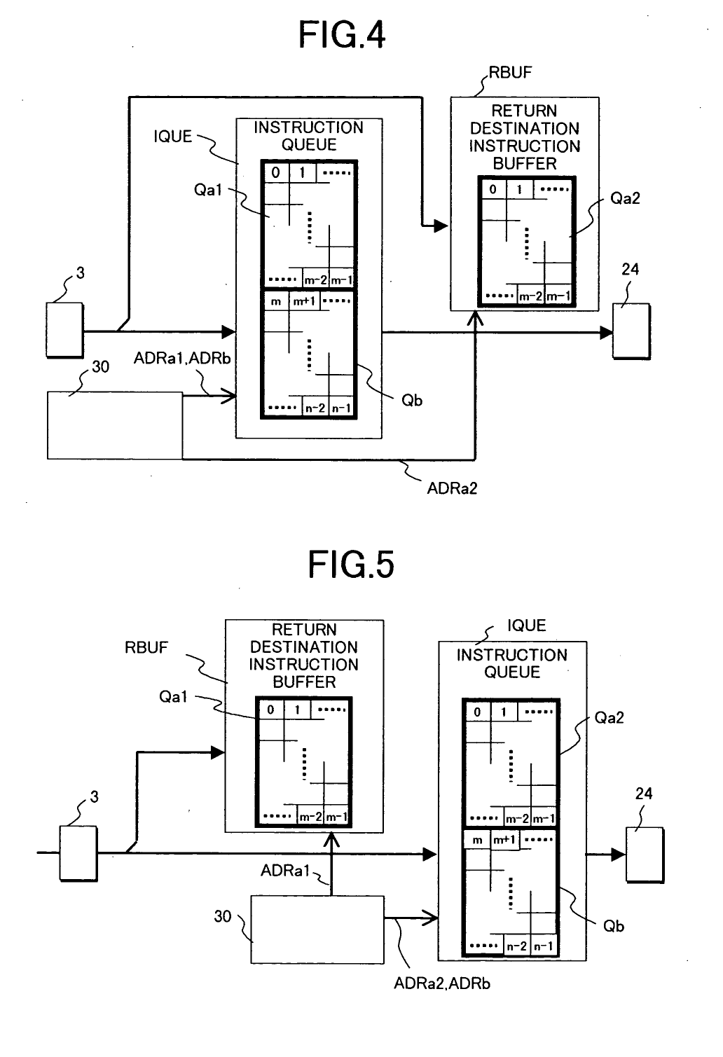

FIG. 4 shows the state where the buffer areas Qa1 and Qb constitute the instruction queue IQUE and the buffer area Qa2 is used as the return destination instruction queue RBUF having m entries. The prediction direction instruction stream is stored in the instruction queue IQUE and the non-prediction direction instruction stream at the time of ntkn is stored in the return destination instruction queue RBUF. When the ntkn prediction fails, allocation of the instruction queue IQUE and the return destination instruction queue RBUF is switched from the state shown in FIG. 4 to the state shown in FIG. 5. The buffer areas Qa2 and Qb constitute the instruction queue IQUE having n continuous entries and the non-prediction direction instruction stream stored in the buffer area Qa2 is supplied as the return destination instruction stream to the instruction decoder 24. Switching of the state from FIG. 4 to FIG. 5 is reflected on the value of the flag FLGrc described above.

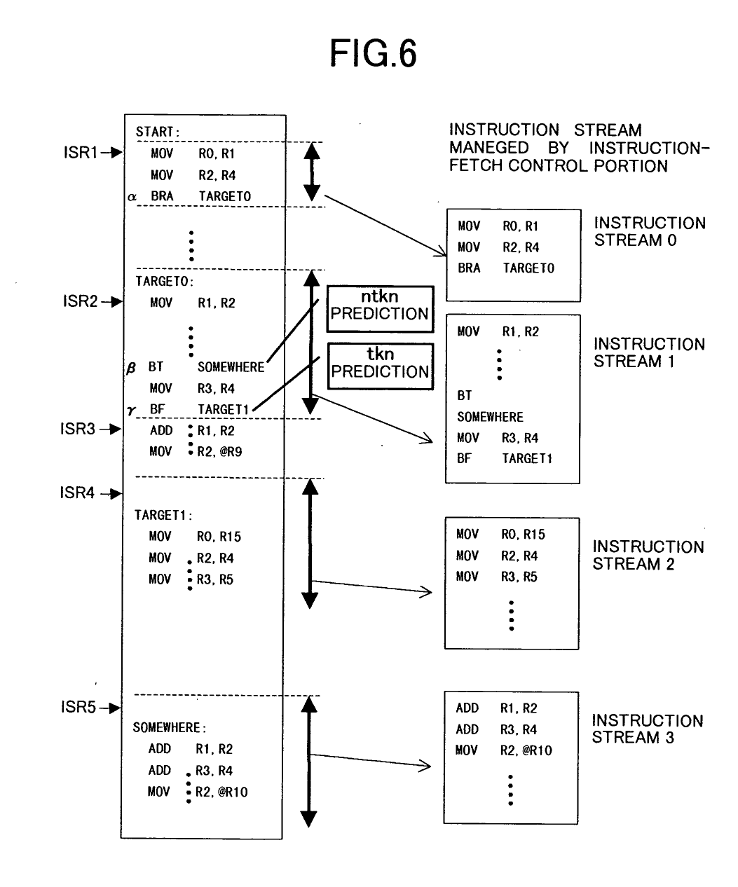

A concrete example of stream management about the instruction stream shown in FIG. 6 by the instruction stream management portion 30 will be explained by way of example.

First, the instruction-fetch control portion 21 defines the starting point and the end point of the instruction stream in the following way. The starting point of the instruction stream is defined as an instruction for starting execution after reset and an instruction of the branch destination. The end point of the instruction stream is defined as an unconditional branch instruction and a conditional branch instruction of the tkn prediction.

The instruction-fetch control portion 21 detects the starting point and the end point of the instruction stream on the basis of the pre-decoding result of the pre-decoder 22. In the example shown in FIG. 6, when the START: of the start of the instruction string is the instruction address the execution of which is started after reset, the instruction-fetch control portion 21 manages the instruction string after the instruction ISR1 as the instruction stream 0. When the instruction-fetch control portion 21 detects the unconditional branch instruction a by the pre-decoding result, the instruction a is set to the end point of the instruction stream 0. The branch destination of the unconditional branch instruction a is the instruction ISR2. The instruction-fetch control portion 21 manages the instructions after the instruction ISR2 as the instruction stream 1. Detecting the conditional branch instruction β by the pre-decoding result, the instruction-fetch control portion 21 refers to the branch prediction device 20 and conducts dynamic branch prediction. Here, the branch prediction result of the conditional branch instruction β is defined as “ntkn prediction”. To exclude the conditional branch prediction of the ntkn prediction from the end point of the stream, the instruction-fetch control portion 21 manages the instruction string after the conditional branch instruction β as the instruction stream 1. Detecting the conditional branch instruction y, the instruction-fetch control portion 21 refers to the branch prediction device 20 in the same way as the conditional branch instruction β and conducts the dynamic branch prediction. Here, the branch prediction result of the conditional branch instruction γ is defined as “tkn prediction”. Since a delay conditional branch instruction of the tkn prediction is the endpoint of the stream, the instruction-fetch control portion uses the instruction γ as the end point of the instruction stream 1.

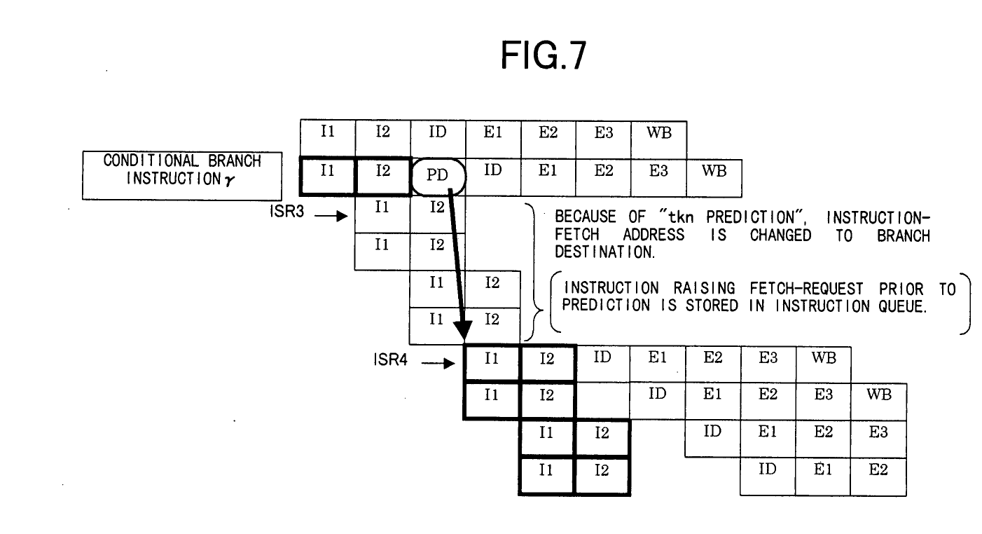

FIG. 7 shows an example of instruction-fetch and pipeline operation of instruction execution in the case of 2-instruction simultaneous fetch and 1-instruction execution. At the time of “tkn prediction” in FIG. 6, an instruction-fetch request for subsequent instruction ISR3 and so forth of the conditional branch instruction γ is raised before pre-decode (PD) of the conditional branch instruction and branch prediction are executed as shown in FIG. 7. The instructions after the instruction ISR3 that are inputted from the ICACH3 are stored at the back of the instruction stream 1. The branch destination of the delay branch instruction γ is an instruction ISR4. The instruction-fetch control portion 21 manages the instructions ISR4 and so forth as the instruction stream 2.

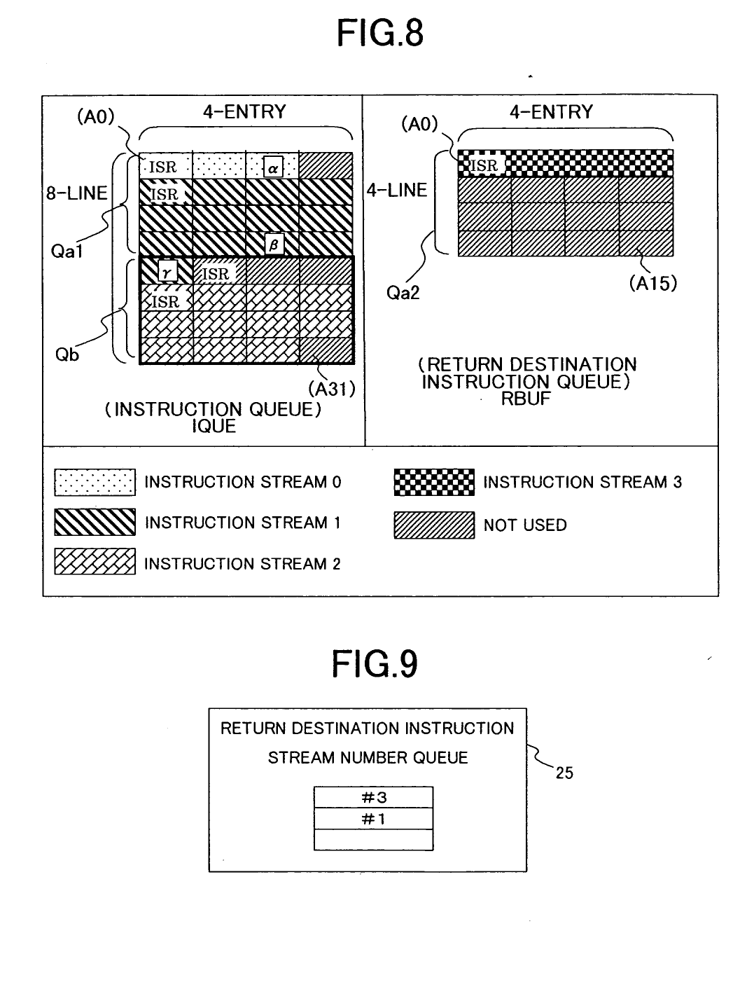

FIG. 8 shows an example where the instruction streams 0 to 3 shown in FIG. 6 are stored in the instruction queue IQUE and the return destination instruction queue RBUF. It will be assumed hereby that the size of each buffer area Qa1, Qa2, Qb is 4 lines in all with 4 entries for each line (16 entries in total; capable of storing 16 instructions). When the buffer areas Qa1 and Qb constitute the instruction queue IQUE and the buffer area Qa2 is the return destination instruction queue RBUF, the instruction streams 0 to 2 are stored in the buffer areas Qa1 and Qb and the instruction stream 3, in the buffer area Qa2. When the conditional branch instruction β does not yet generate the ID stage, the state of the two conditional branch instructions β and γ is the state of speculation execution as to the instruction-fetch. At this time, the instruction stream number 3 (#3) that is to be the return destination when the prediction of the conditional branch instruction β first executed misses and the instruction stream number 1 (#1) that is to be the return destination when the conditional branch instruction γ executed secondarily misses enter the return destination instruction stream number queue 25 as exemplarily shown in FIG. 9. When the instruction stream management portion 30 shown in FIG. 1 can manage four instruction streams, speculation of the instruction-fetch for maximum 3 branch instructions can be executed. In short, this means that the non-prediction direction instruction stream of each of the maximum 3 branch instructions can be stored in the queuing buffer 23.

Here, the explanation will be given on the state of the address pointers rpi and wpi when the instruction queue IQUE and the return destination instruction queue RBU are under the state shown in FIG. 8. The entry address of the instruction queue IQUE is from A0 of the upper left entry to A31 of the lower right entry and the entry address of the return destination instruction queue RBUF is from A0 of the upper left entry to A15 of the lower right entry. It will be assumed that the instruction-fetch from the instruction queue IQUE proceeds to an intermediate address A30 of the instruction stream 2 and that the instruction decode proceeds to an intermediate address A1 of the instruction stream 0. The address pointers corresponding to the instruction stream 0 at this time are rp0=A1 and wp0=A2. The address pointers corresponding to the instruction stream 1 are rp1=A4 and wp1=A16. The address pointers corresponding to the instruction stream 2 are rp2=A20 and wp2=A30. The address pointers corresponding to the instruction stream 3 are rp3=A0 and wp3=A3.

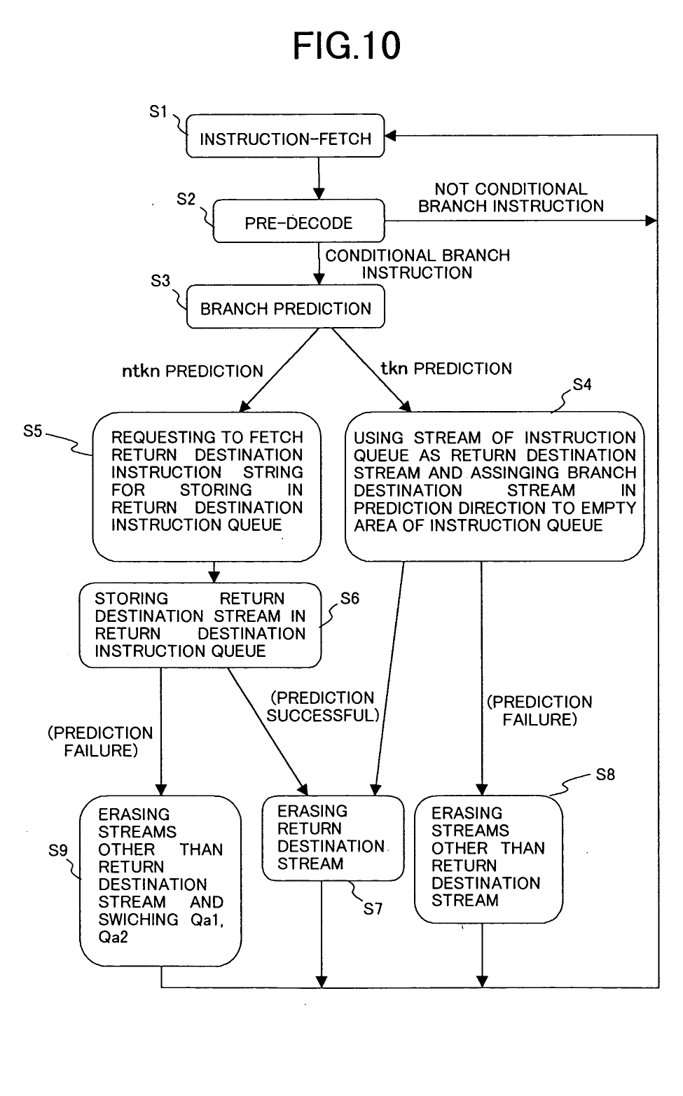

FIG. 10 shows the procedure of the instruction stream control by the instruction-fetch control portion 21 described above. When an instruction is inputted to the instruction control portion 11 in accordance with the instruction-fetch instruction from the external memory (S1), the instruction is pre-decoded (S2). When the instruction so pre-decoded is not the conditional branch instruction, a next instruction of the instruction-fetch is awaited. When the pre-decoded instruction is the conditional branch instruction, branch prediction is executed (S3). In the case of the tkn predication, the stream of the instruction queue is stored as the return destination, that is, the non-prediction direction instruction stream, in the empty area of the instruction queue IQE. The instruction stream of the branch destination as the prediction direction is stored in another empty area of the instruction queue IQUE (S4). In the case of the ntkn prediction, on the other hand, the fetch-request of the return destination instruction string to be stored in the return destination instruction queue RBUF is created (S5) and the non-prediction direction instruction stream as the return destination instruction stream is stored in the return destination instruction queue RBUF (S6). The fetch-request of the instruction of the prediction direction (here, ntkn prediction) is thereafter outputted and the requested instruction is stored in the instruction queue IQE.

In both tkn prediction and ntkn prediction, when the success of prediction is recognized by the instruction execution, the return destination instruction stream having the branch instruction relating to the success of prediction as the starting point is erased (S7). When the failure of prediction is recognized by the instruction execution in the tkn prediction, the streams other than the return destination instruction stream having the branch instruction relating to the failure of prediction as the starting point are erased (S8). When the failure of prediction is recognized by the instruction execution in the ntkn prediction, the streams other than the return destination instruction stream having the branch instruction relating to the failure of prediction as the starting point are erased and the functions of the buffer areas Qa1 and Qa2 are switched (S9).

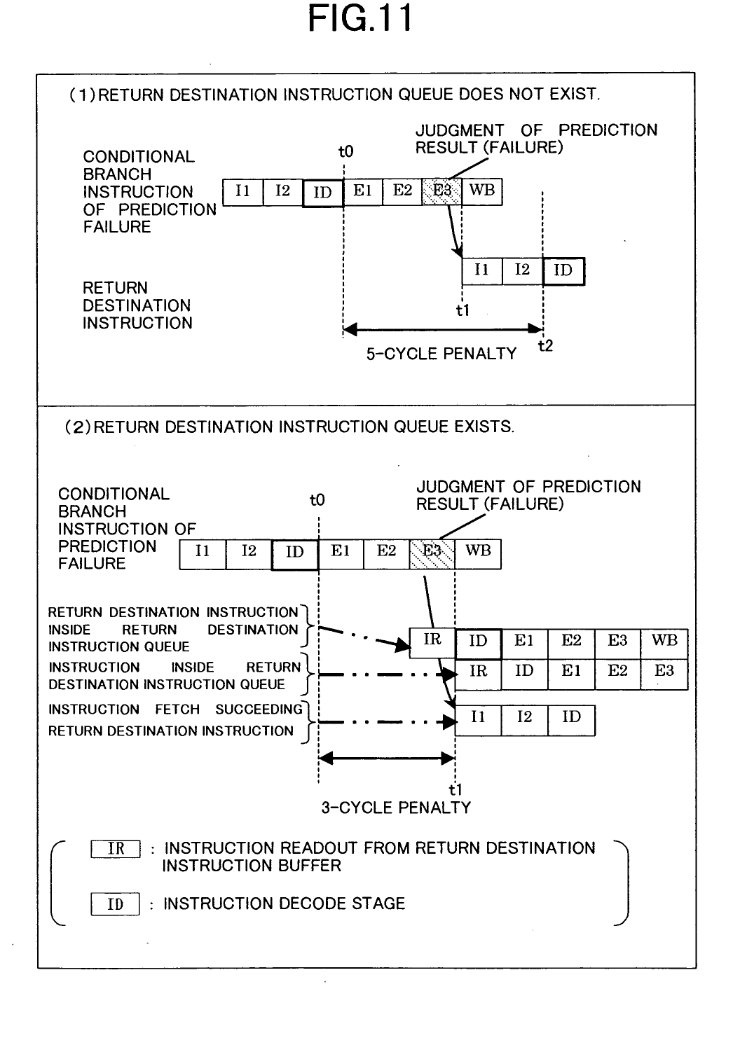

FIG. 11 typically shows the effect by the return destination instruction queue at the time of the failure of the branch prediction. Assuming that three cycles are necessary for the judgment of the prediction result from decode (t0) of the conditional branch instruction of the prediction failure, for example, the return destination instruction must be fetched from the point (t1) at which the judgment result of the prediction result failure is acquired unless the return destination instruction queue exists. When two cycles are necessary for the instruction-fetch, a penalty cycle of five cycles in total occurs till decoding of the return destination instruction (t2). When the non-prediction direction instruction stream is stored in the return destination instruction queue or the like, in contrast, the return destination instruction is read out from the return destination instruction queue in response to the failure judgment of the prediction result and that instruction can be supplied to the instruction decoder. When at least the instruction to be next executed is stored in the return destination instruction queue, it becomes possible to serially execute without interruption the instruction relating to the branch prediction failure after the penalty cycle of three cycles when the fetch of the instructions following the return destination instruction from the cycle of the time t1 is started. In this way, the penalty of the branch failure can be reduced from five cycles to three cycles in comparison with the case where the return destination instruction queue does not exist.

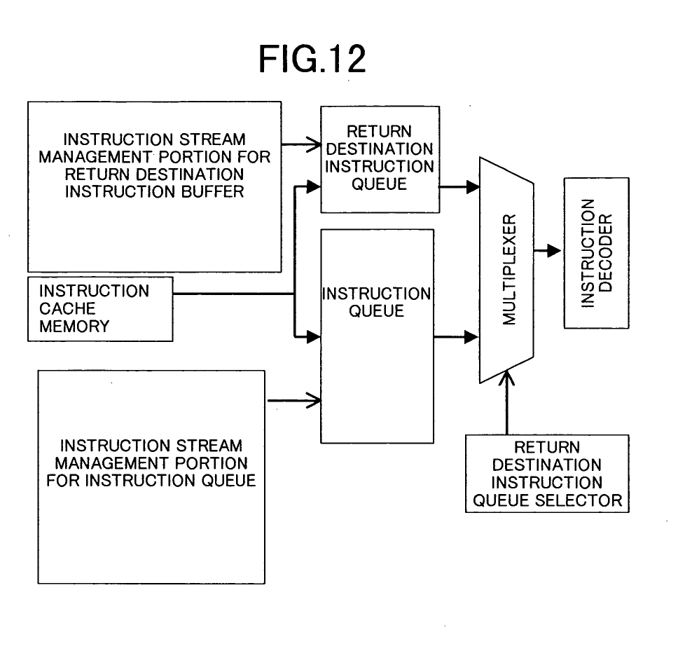

FIG. 12 shows a comparative example corresponding to FIG. 1. The return destination instruction queue and the instruction queue are disposed separately and independently and correspondingly, the instruction stream management portions are disposed separately and independently for the return destination instruction queue and the instruction queue, respectively. When the branch prediction fails, the instruction string of the return destination is supplied from the return destination instruction queue to the instruction decoder. In parallel with the supply of the instruction from the return destination instruction queue to the instruction decoder, the succeeding instruction strings are fetched and stored in the instruction queue. When the return destination instructions stored in the return destination instruction queue run out, the instructions are supplied from the instruction queue to the instruction decoder. Since the read/write pointers for the instruction queue and the return destination instruction queue must be separately managed, pointer management becomes complicated. According to the construction shown in FIG. 1, when a part of the instruction queue IQUE and the return destination instruction queue RBUF are replaced, the return destination instruction can be supplied to the instruction decoder by using the read pointer of the instruction stream. Since return operation can be accomplished in this way by the stream management, too, without using fixedly and discretely the instruction key and the return destination instruction queue, the control logic at the time of the branch prediction failure can be simplified and the processing speed can be improved, too.

Although the invention completed by the inventor has thus been explained concretely about the embodiment, the invention is not particularly limited to the embodiment but can be changed or modified in various ways without departing from the scope and spirit of the invention.

For example, the number of buffer areas constituting the queuing buffer and the entry capacity can be appropriately changed. The CPU is not particularly limited to the two-way super-scalar and may be a single scalar. The circuit modules mounted to the microprocessor can be appropriately changed, too. Furthermore, the invention is not limited to one-chip data procesor but may well have a multi-chip construction.

For example, the instruction stream stored in the return destination instruction queue can store four lines and four instruction streams but the number of lines stored and the number of instruction streams stored may be changed appropriately.

The microprocessor may be of the type which has therein an instruction storage area executed by the CPU and an internal memory as a work area.

The microprocessor, the external memory and other peripheral circuits not shown in the drawings may be formed on one semiconductor substrate. Alternatively, the microprocessor, the external memory and other peripheral circuits may be formed on separate semiconductor substrates and these substrates may be sealed into one package.

1. A data processor for executing branch prediction, comprising:
a queuing buffer allocated to an instruction queue and to a return destination instruction queue and having address pointers managed for each instruction stream; and
a control portion for the queuing buffer;
wherein the control portion stores a prediction direction instruction stream and a non-prediction direction instruction stream in the queuing buffer and switches an instruction stream as an execution object from the prediction direction instruction stream to the non-prediction direction instruction stream inside the queuing buffer in response to failure of branch prediction.

2. A data processor as defined in claim 1, wherein the queuing buffer includes first and second storage areas to which the same physical address is allocated, and allocation of either one of the first and second storage areas to the instruction queue and the other to the return destination instruction queue is changeable.

3. A data processor as defined in claim 2, which further includes a third storage area to which a physical address continuing the physical addresses allocated respectively to the first and second storage areas is allocated, and wherein the third storage area is allocated to a part of the instruction queue continuing the first or second storage area allocated to the instruction queue.

4. A data processor as defined in claim 1, wherein the control portion stores the non-prediction direction instruction stream in the return destination instruction queue when the branch prediction is non-branch.

5. A data processor as defined in claim 4, wherein the control portion stores the non-prediction direction instruction stream in an empty area of the instruction queue when the branch prediction is branch.

6. A data processor as defined in claim 5, wherein the control portion switches allocation of the return destination instruction queue to the instruction queue and the instruction queue to the return destination instruction queue in response to the failure of branch prediction when the non-prediction direction instruction stream exists in the return destination instruction queue.

7. A data processor as defined in claim 6, wherein the control portion uses the non-prediction direction instruction stream of an empty area as the instruction stream to be executed in response to the failure of branch prediction when the non-prediction direction instruction stream exists in the empty area of the instruction queue and stores the prediction direction instruction stream in succession to the non-prediction direction instruction stream.

8. A data processor as defined in claim 7, which further includes re-writable flag means for representing whether address pointers are address pointers of the instruction queue or address pointers of the return destination instruction queue, as a pair with the address pointer.

9. A data processor as defined in claim 7, which further includes storage means for storing information for linking the non-prediction direction instruction stream stored in the queuing buffer with branch instruction relating to prediction of the non-prediction direction instruction stream.

10. A data processor as defined in claim 9, wherein the storage means is a return instruction stream number queue for serially storing identification information of the non-prediction direction instruction stream stored in the queuing buffer in the sequence of execution of branch instruction.

11. A data processor for executing branch prediction, comprising:
a queuing buffer allocated to an instruction queue and to a return destination instruction queue and having address pointers managed for each instruction stream; and
a control portion for the queuing buffer;
wherein the control portion stores a prediction direction instruction stream in the instruction queue, stores a non-prediction direction instruction stream in a return destination instruction queue when branch prediction is non-branch and stores the non-prediction direction instruction stream in an empty area of the instruction queue when branch prediction is branch.

12. A data processor as defined in claim 11, wherein the control portion switches an instruction stream as an execution object from the prediction direction instruction stream inside the queuing buffer to the non-prediction direction instruction stream in response to the failure of branch prediction.

13. A data processor as defined in claim 12, wherein the control portion switches allocation of the return destination instruction to the instruction queue and the instruction queue to the return destination instruction queue in response to the failure of branch prediction when the non-prediction direction instruction stream exists in the return destination instruction queue.

14. A data processor as defined in claim 13, wherein the control portion uses the non-prediction direction instruction stream of an empty area as the instruction stream to be executed in response to the failure of branch prediction when the non-prediction direction instruction stream exists in the empty area of the instruction queue and stores the prediction direction instruction stream in succession to the non-prediction direction instruction stream.

15. A data processor as defined in claim 14, which further includes re-writable flag means for representing whether address pointers are address pointers of the instruction queue or address pointers of the return destination instruction queue, as a pair with the address pointer.

16. A data processor as defined in claim 11, which further includes storage means for storing information for linking the non-prediction direction instruction stream stored in the queuing buffer with branch instruction relating to prediction of the non-prediction direction instruction stream.

17. A data processor as defined in claim 16, wherein the storage means is a return instruction stream number queue for serially storing identification information of the non-prediction direction instruction stream stored in the queuing buffer in the sequence of execution of branch instruction.

18. A data processor as defined in claim 1, wherein an instruction as a starting point of the instruction stream contains an instruction the execution of which is started after resetting and a branch destination instruction, and an instruction as an end point of the instruction stream contains an unconditional branch instruction and a conditional branch instruction of branch prediction.

19. A data processor as defined in claim 1, wherein the queuing buffer and its control portion are arranged in an instruction control portion of a central processing unit.

20. A data processor as defined in claim 19, which further includes an instruction cache memory connected to the central processing unit and is formed on a semiconductor chip.
